(19) United States
(12) Patent Application Publication
(10) Pub. No.: US 2024/0428109 A1
(43) Pub. Date: Dec. 26, 2024

(54) MULTI-APERTURE LARGE FIELD-OF-VIEW RAMAN SYSTEM

(71) Applicant: IonQ, Inc., College Park, MD (US)

(72) Inventors: Joachim WELTE, Carrboro, NC (US); Kai Makoto HUDEK, Hyattsville, MD (US)

(21) Appl. No.: 18/435,368

(22) Filed: Feb. 7, 2024

Related U.S. Application Data
(60) Provisional application No. 63/483,683, filed on Feb. 7, 2023.

(51) Int. Cl. G06N 10/40; G02B 1/00; G02B 3/00; G02B 3/04

(52) U.S. Cl. CPC G06N 10/40; G02B 1/002; G02B 3/0037; G02B 3/04

(57) ABSTRACT

Aspects of the present disclosure relate generally to systems and methods for use in the implementation and/or operation of quantum information processing (QIP) systems including an ion trap and a multiple-zone addressing system, and more particularly, to a large field-of-view Raman system having a micro-or metalens array. In some aspects, the ion trap is configured to confine at least a first trapped ion chain and a second trapped ion chain. In some aspects, the multiple zone addressing system includes a first optical addresser, a second optical addresser, and a combining region.

### CROSS-REFERENCE TO RELATED APPLICATION

This application claims the benefit of U.S. Provisional Patent Application No. 63/483,683, filed Feb. 7, 2023, the entire contents of which are hereby incorporated by reference.

### TECHNICAL FIELD

Aspects of the present disclosure relate generally to systems and methods for use in the implementation, operation, and/or use of quantum information processing (QIP) systems.

### BACKGROUND

Trapped atoms are one of the leading implementations for quantum information processing or quantum computing. Atomic-based qubits may be used as quantum memories, as quantum gates in quantum computers and simulators, and may act as nodes for quantum communication networks. Qubits based on trapped atomic ions enjoy a rare combination of attributes. For example, qubits based on trapped atomic ions have very good coherence properties, may be prepared and measured with nearly 100% efficiency, and are readily entangled with each other by modulating their Coulomb interaction with suitable external control fields such as optical or microwave fields. These attributes make atomic-based qubits attractive for extended quantum operations such as quantum computations or quantum simulations.

It is therefore important to develop new techniques that improve the design, fabrication, implementation, control, and/or functionality of different QIP systems used as quantum computers or quantum simulators, and particularly for those QIP systems that handle operations based on atomic-based qubits.

### SUMMARY

The following presents a simplified summary of one or more aspects to provide a basic understanding of such aspects. This summary is not an extensive overview of all contemplated aspects and is intended to neither identify key or critical elements of all aspects nor delineate the scope of any or all aspects. Its sole purpose is to present some concepts of one or more aspects in a simplified form as a prelude to the more detailed description that is presented later.

This disclosure describes various aspects of quantum information processing (QIP) systems that include large field-of-view (FOV) Raman systems configured to address large fields of view. For example, such systems may be configured to address multiple discrete sub-FOVs within a large FOV using a multi-aperture approach. Such systems are suitable for addressing ion traps that include more than one chain of trapped ions.

In some aspects, a QIP system includes an ion trap and a multiple-zone addressing system. The ion trap is configured to confine at least a first trapped ion chain and a second trapped ion chain. The multiple-zone addressing system includes a first optical addresser, a second optical addresser, and a combining region. The first optical addresser is configured to control a first beam configured to address a first addressing zone including the first trapped ion chain. The second optical addresser is configured to control a second beam configured to address a second addressing zone including the second trapped ion chain. The combining region is configured to reduce a fill factor of the first beam and the second beam while maintaining spatial separation of the first beam and the second beam.

In some aspects, a QIP system includes an ion trap and an addressing system. The ion trap includes at least one addressing zone including a trapped ion chain. The addressing system is configured to address the at least one addressing zone of the ion trap. The addressing system includes an optical addresser and a microlens array or a metalens array. The optical addresser is configured to control a beam configured to address the at least one addressing zone including the trapped ion chain. The microlens array includes a microlens configured to focus the beam on the trapped ion chain. The metalens array includes a metalens configured to focus the beam on the trapped ion chain.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

The disclosed aspects will hereinafter be described in conjunction with the appended drawings, provided to illustrate and not to limit the disclosed aspects, wherein like designations denote like elements, and in which:

FIG. 1 illustrates a view of atomic ions of a linear crystal or chain in accordance with aspects of this disclosure.

FIG. 2 illustrates an example of a quantum information processing (QIP) system in accordance with aspects of this disclosure.

FIG. 3 illustrates an example of a computer device in accordance with aspects of this disclosure.

FIG. 4 illustrates an example QIP system configured to simultaneously address four chains of trapped ions, in accordance with aspects of this disclosure.

FIG. 5 illustrates a detail view of the QIP system of FIG. 4 indicated by bracket 5 in FIG. 4.

FIG. 6 illustrates a detail view of the QIP system of FIG. 4 indicated by bracket 6 in FIG. 4.

FIG. 7 illustrates a detail view of the QIP system of FIG. 4 indicated by bracket 7 in FIG. 4.

FIG. 8 illustrates a detail view of a portion of a QIP system including metalenses.

### DETAILED DESCRIPTION

The detailed description set forth below in connection with the appended drawings or figures is intended as a description of various configurations or implementations and is not intended to represent the only configurations or implementations in which the concepts described herein may be practiced. The detailed description includes specific details for the purpose of providing a thorough understanding of various concepts. However, it will be apparent to those skilled in the art that these concepts may be practiced without these specific details or with variations of these specific details. In some instances, well known components are shown in block diagram form, while some blocks may be representative of one or more well-known components.

Scaling up quantum information processing (QIP) systems will ultimately involve coupling quantum computing chips into a quantum network (e.g., including photonic interconnects). It is desirable to increase a number of qubits per chip when scaling up QIP systems. However, the chains of trapped ions used in the ion traps of current QIP systems experience a decrease in stability as the length of the trapped ion chains increases. Therefore, increasing the number of qubits on a chip is not a matter of simply increasing the number of ions in a trapped ion chain. Instead of increasing the length of the trapped ion chains, multiple trapped ion chains (also called “cores”) may be incorporated in a single quantum computing chip (e.g., ion trap). These multiple trapped ion chains may be entangled with each other via transport and swap operations, which can allow the multiple trapped ion chains to act like a network of ion chains. In some aspects, photonic interconnects may be used to entangle ion chains within each other via transport and swap operations, or via photonic interconnects within a single quantum computing chip.

When implemented in a multiple chain configuration, the multiple trapped ion chains of the ion trap will be in close proximity to each other. Therefore, the optical addressers for addressing individual qubits and performing gate operations of QIP systems that include ion traps having multiple chains of trapped ions are modified (e.g., different from optical addressers used in single ion chain systems). For example, in order to avoid optical crosstalk between adjacent ions in a single ion chain, addressing beams should have a beam waist of much less than the ion spacing. For example, in an ion chain with an ion spacing of 3 microns (μm), the addressing beams may have a beam waist of less than 1.5 μm (i.e. a beam diameter of less than 30 μm). In another example, in order to avoid optical crosstalk between adjacent trapped ion chains, the trapped ion chains may be separated by a distance great enough to mitigate the effects of spontaneous emission. For example, for an ion chain of 64 ions and an ion spacing of 3 μm, a center-to-center spacing of adjacent trapped ion chains may be at least 1080 μm. In some aspects, such configurations may have a minimum center-to-center spacing of adjacent trapped ions that may be at least 400 μm. Given these size constraints, a “fill factor” of the addressing zone would only be about 20% for an example system including trapped ion chains that are 200 μm long and have 1080 μm of chain separation. As used herein the phrase “fill factor” refers to a collective beam diameter of the beams formed by a particular addresser relative to the spacing of the addressing zones. In an example including four trapped ion chains, an addressing window would therefore be about 4 mm. If the optical addressing system were to uniformly address the full 4 mm FOV, it would be inefficient in terms of entendue (e.g., amount of beam spreading) required and fill factor being used.

However, conventional QIP systems have a single addressing region for addressing ions that typically has less than a 200 μm field of view (FOV). Therefore, this conventional addressing region is too small for addressing multiple chains of trapped ions.

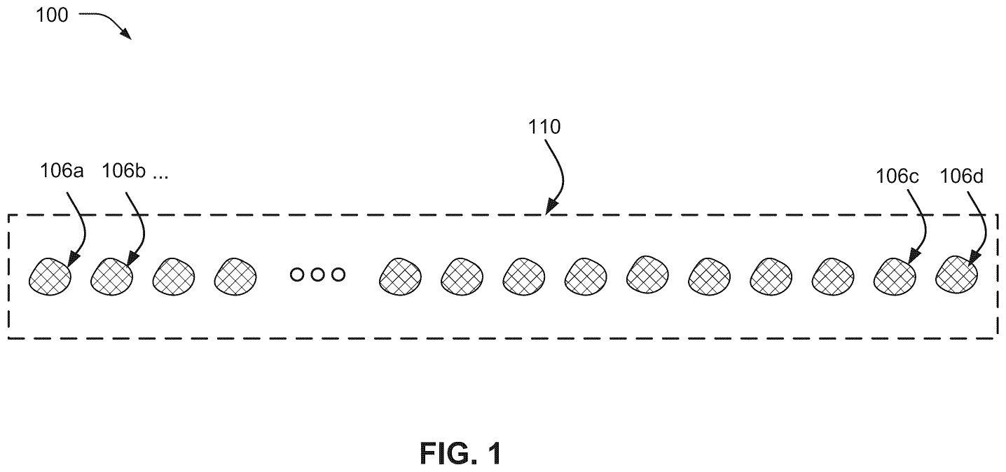

Solutions to the issues described above are explained in more detail in connection with FIGS. 1-8, with FIGS. 1-3 providing a background of QIP systems or quantum computers, and more specifically, of atomic-based QIP systems or quantum computers.

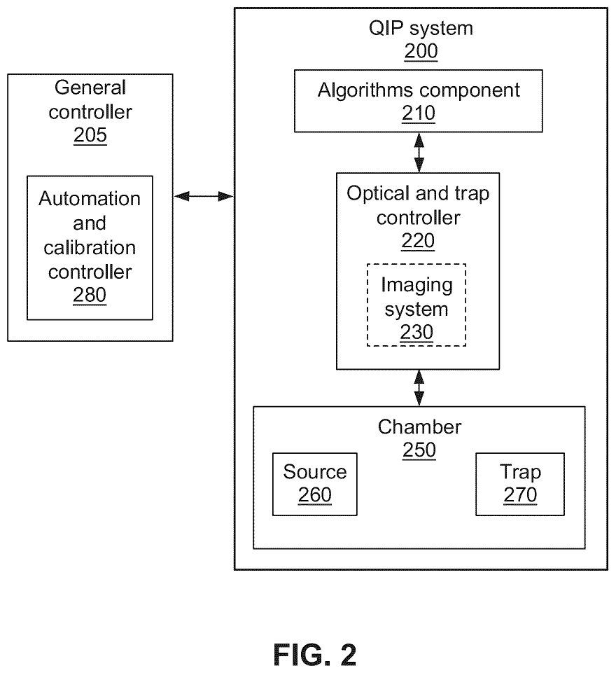

FIG. 1 illustrates a diagram 100 with multiple atomic ions or ions 106 (e.g., ions 106a, 106b, . . . , 106c, and 106d) trapped in a linear crystal or chain 110 using a trap (not shown; the trap can be inside a vacuum chamber as shown in FIG. 2). The trap maybe referred to as an ion trap. The ion trap shown may be built or fabricated on a semiconductor substrate, a dielectric substrate, or a glass die or wafer (also referred to as a glass substrate). The ions 106 may be provided to the trap as atomic species for ionization and confinement into the chain 110. Some or all of the ions 106 may be configured to operate as qubits in a QIP system.

In the example shown in FIG. 1, the trap includes electrodes for trapping or confining multiple ions into the chain 110 laser-cooled to be nearly at rest. The number of ions trapped can be configurable and more or fewer ions may be trapped. The ions can be Ytterbium ions (e.g., ¹⁷¹Yb⁺ ions), for example. The ions are illuminated with laser (optical) radiation tuned to a resonance in ¹⁷¹Yb⁺ and the fluorescence of the ions is imaged onto a camera or some other type of detection device (e.g., photomultiplier tube (PMT)). In this example, ions may be separated by a few microns (m) from each other, although the separation may vary based on architectural configuration. The separation of the ions is determined by a balance between the external confinement force and Coulomb repulsion and does not need to be uniform. Moreover, in addition to Ytterbium ions, neutral atoms, Rydberg atoms, or other types of atomic-based qubit technologies may also be used. Moreover, ions of the same species, ions of different species, and/or different isotopes of ions may be used. The trap may be a linear RF Paul trap, but other types of confinement devices may also be used, including optical confinements. Thus, a confinement device may be based on different techniques and may hold ions, neutral atoms, or Rydberg atoms, for example, with an ion trap being one example of such a confinement device. The ion trap may be a surface trap, for example.

FIG. 2 illustrates a block diagram that shows an example of a QIP system 200. The QIP system 200 may also be referred to as a quantum computing system, a quantum computer, a computer device, a trapped ion system, or the like. The QIP system 200 may be part of a hybrid computing system in which the QIP system 200 is used to perform quantum computations and operations and the hybrid computing system also includes a classical computer to perform classical computations and operations. The quantum and classical computations and operations may interact in such a hybrid system.

Shown in FIG. 2 is a general controller 205 configured to perform various control operations of the QIP system 200. These control operations may be performed by an operator, may be automated, or a combination of both. Instructions for at least some of the control operations may be stored in memory (not shown) in the general controller 205 and may be updated over time through a communications interface (not shown). Although the general controller 205 is shown separate from the QIP system 200, the general controller 205 may be integrated with or be part of the QIP system 200. The general controller 205 may include an automation and calibration controller 280 configured to perform various calibration, testing, and automation operations associated with the QIP system 200. These calibration, testing, and automation operations may involve, for example, all or part of an algorithms component 210, all or part of an optical and trap controller 220 and/or all or part of a chamber 250.

The QIP system 200 may include the algorithms component 210 mentioned above, which may operate with other parts of the QIP system 200 to perform or implement quantum algorithms, quantum applications, or quantum operations. The algorithms component 210 may be used to perform or implement a stack or sequence of combinations of single qubit operations and/or multi-qubit operations (e.g., two-qubit operations) as well as extended quantum computations. The algorithms component 210 may also include software tools (e.g., compilers) that facilitate such performance or implementation. As such, the algorithms component 210 may provide, directly or indirectly, instructions to various components of the QIP system 200 (e.g., to the optical and trap controller 220) to enable the performance or implementation of the quantum algorithms, quantum applications, or quantum operations. The algorithms component 210 may receive information resulting from the performance or implementation of the quantum algorithms, quantum applications, or quantum operations and may process the information and/or transfer the information to another component of the QIP system 200 or to another device (e.g., an external device connected to the QIP system 200) for further processing.

The QIP system 200 may include the optical and trap controller 220 mentioned above, which controls various aspects of a trap 270 in the chamber 250, including the generation of signals to control the trap 270. The optical and trap controller 220 may also control the operation of lasers, optical systems, and optical components that are used to provide the optical beams that interact with the atoms or ions in the trap. Optical systems that include multiple components may be referred to as optical assemblies. The optical beams are used to set up the ions, to perform or implement quantum algorithms, quantum applications, or quantum operations with the ions, and to read results from the ions. Control of the operations of laser, optical systems, and optical components may include dynamically changing operational parameters and/or configurations, including controlling positioning using motorized mounts or holders. When used to confine or trap ions, the trap 270 may be referred to as an ion trap. The trap 270, however, may also be used to trap neutral atoms, Rydberg atoms, and other types of atomic-based qubits. The lasers, optical systems, and optical components can be at least partially located in the optical and trap controller 220, an imaging system 230, and/or in the chamber 250.

The QIP system 200 may include the imaging system 230. The imaging system 230 may include a high-resolution imager (e.g., CCD camera) or other type of detection device (e.g., PMT) for monitoring the ions while they are being provided to the trap 270 and/or after they have been provided to the trap 270 (e.g., to read results). In an aspect, the imaging system 230 can be implemented separate from the optical and trap controller 220, however, the use of fluorescence to detect, identify, and label ions using image processing algorithms may need to be coordinated with the optical and trap controller 220.

In addition to the components described above, the QIP system 200 can include a source 260 that provides atomic species (e.g., a plume or flux of neutral atoms) to the chamber 250 having the trap 270. When atomic ions are the basis of the quantum operations, that trap 270 confines the atomic species once ionized (e.g., photoionized). The trap 270 may be part of what may be referred to as a processor or processing portion of the QIP system 200. That is, the trap 270 may be considered at the core of the processing operations of the QIP system 200 since it holds the atomic-based qubits that are used to perform or implement the quantum operations or simulations. At least a portion of the source 260 may be implemented separate from the chamber 250.

It is to be understood that the various components of the QIP system 200 described in FIG. 2 are described at a high-level for ease of understanding. Such components may include one or more sub-components, the details of which may be provided below as needed to better understand certain aspects of this disclosure.

Aspects of this disclosure may be implemented at least partially using the optical lasers, optical systems, optical components, and ion trap 270 described above.

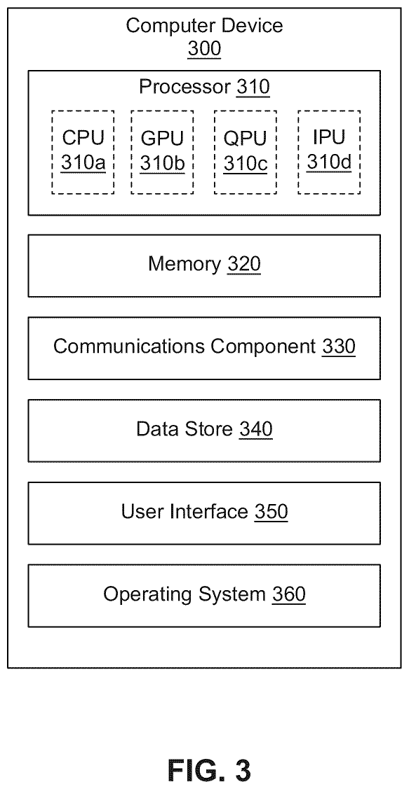

Referring now to FIG. 3, an example of a computer system or device 300 is shown. The computer device 300 may represent a single computing device, multiple computing devices, or a distributed computing system, for example. The computer device 300 may be configured as a quantum computer (e.g., a QIP system), a classical computer, or to perform a combination of quantum and classical computing functions, sometimes referred to as hybrid functions or operations. For example, the computer device 300 may be used to process information using quantum algorithms, classical computer data processing operations, or a combination of both. In some instances, results from one set of operations (e.g., quantum algorithms) are shared with another set of operations (e.g., classical computer data processing). A generic example of the computer device 300 implemented as a QIP system capable of performing quantum computations and simulations is, for example, the QIP system 200 shown in FIG. 2.

The computer device 300 may include a processor 310 for carrying out processing functions associated with one or more of the features described herein. The processor 310 may include a single processor, multiple set of processors, or one or more multi-core processors. Moreover, the processor 310 may be implemented as an integrated processing system and/or a distributed processing system. The processor 310 may include one or more central processing units (CPUs) 310a, one or more graphics processing units (GPUs) 310b, one or more quantum processing units (QPUs) 310c, one or more intelligence processing units (IPUs) 310d (e.g., artificial intelligence or Al processors), or a combination of some or all those types of processors. In one aspect, the processor 310 may refer to a general processor of the computer device 300, which may also include additional processors 310 to perform more specific functions (e.g., including functions to control the operation of the computer device 300). Quantum operations may be performed by the QPUs 310c. Some or all of the QPUs 310c may use atomic-based qubits, however, it is possible that different QPUs are based on different qubit technologies.

The computer device 300 may include a memory 320 for storing instructions executable by the processor 310 to carry out operations. The memory 320 may also store data for processing by the processor 310 and/or data resulting from processing by the processor 310. In an implementation, for example, the memory 320 may correspond to a computer-readable storage medium that stores code or instructions to perform one or more functions or operations. Just like the processor 310, the memory 320 may refer to a general memory of the computer device 300, which may also include additional memories 320 to store instructions and/or data for more specific functions.

It is to be understood that the processor 310 and the memory 320 may be used in connection with different operations including but not limited to computations, calculations, simulations, controls, calibrations, system management, and other operations of the computer device 300, including any methods or processes described herein.

Further, the computer device 300 may include a communications component 330 that provides for establishing and maintaining communications with one or more parties utilizing hardware, software, and services. The communications component 330 may also be used to carry communications between components on the computer device 300, as well as between the computer device 300 and external devices, such as devices located across a communications network and/or devices serially or locally connected to computer device 300. For example, the communications component 330 may include one or more buses, and may further include transmit chain components and receive chain components associated with a transmitter and receiver, respectively, operable for interfacing with external devices. The communications component 330 may be used to receive updated information for the operation or functionality of the computer device 300.

Additionally, the computer device 300 may include a data store 340, which can be any suitable combination of hardware and/or software, which provides for mass storage of information, databases, and programs employed in connection with the operation of the computer device 300 and/or any methods or processes described herein. For example, the data store 340 may be a data repository for operating system 360 (e.g., classical OS, or quantum OS, or both). In one implementation, the data store 340 may include the memory 320. In an implementation, the processor 310 may execute the operating system 360 and/or applications or programs, and the memory 320 or the data store 340 may store them.

The computer device 300 may also include a user interface component 350 configured to receive inputs from a user of the computer device 300 and further configured to generate outputs for presentation to the user or to provide to a different system (directly or indirectly). The user interface component 350 may include one or more input devices, including but not limited to a keyboard, a number pad, a mouse, a touch-sensitive display, a digitizer, a navigation key, a function key, a microphone, a voice recognition component, any other mechanism capable of receiving an input from a user, or any combination thereof. Further, the user interface component 350 may include one or more output devices, including but not limited to a display, a speaker, a haptic feedback mechanism, a printer, any other mechanism capable of presenting an output to a user, or any combination thereof. In an implementation, the user interface component 350 may transmit and/or receive messages corresponding to the operation of the operating system 360. When the computer device 300 is implemented as part of a cloud-based infrastructure solution, the user interface component 350 may be used to allow a user of the cloud-based infrastructure solution to remotely interact with the computer device 300.

In connection with the systems described in FIGS. 1-3, a Raman zone optical system having multiple addressing zones is described below. Each of the addressing zones is configured to address one of the trapped ion chains of the ion trap 270, while limiting crosstalk with neighboring trapped ion chains of the ion trap 270.

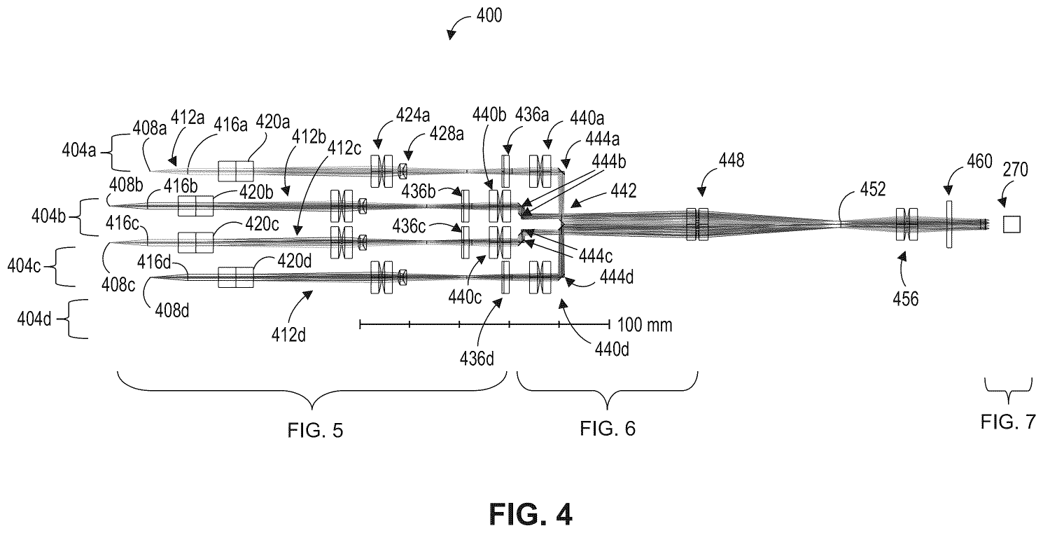

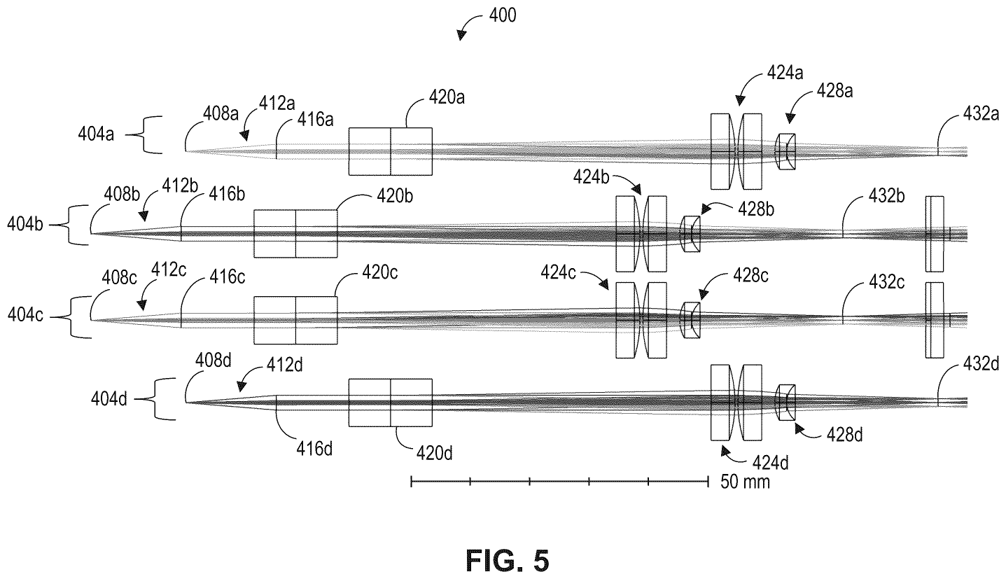

FIG. 4 illustrates a multiple-zone Raman optical system 400 that includes metalenses or microlenses according to example aspects. FIGS. 5, 6, and 7 illustrate enlarged portions of the multiple-zone Raman optical system 400. In the example embodiment illustrated in FIG. 4, the optical system 400 is telecentric in the ion plane and the ion trap 270 is configured to confine four ion chains that are spaced approximately 1 millimeter (mm) apart. In other aspects, the ion trap 270 may be configured to confine more or fewer ion chains. It should be appreciated that the ion chains can correspond to ion chain 100 in FIG. 1. Moreover, the optical system 400 can be implemented as a component of the optical and trap controller 220 configured to control the ion chain(s) in trap 270 of FIG. 2 accordingly to an exemplary aspect.

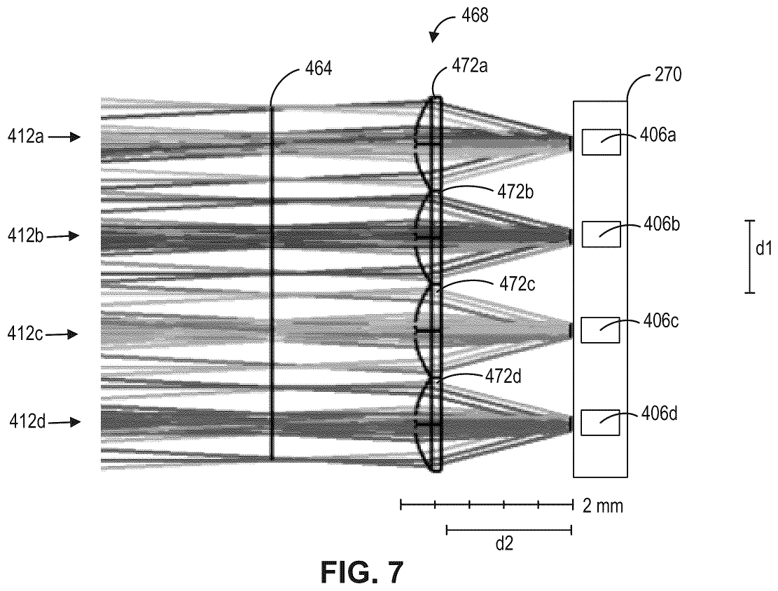

The system 400 includes an optical addresser 404a configured control a first beam 412a to address a first addressing region including the first ion chain 406a (e.g., FIG. 7), a second optical addresser 404b configured to control a second beam 412b to address a second addressing region including the second ion chain 406b (e.g., FIG. 7), a third optical addresser 404c configured to control a third beam 412c to address a third addressing region including the third ion chain 406c (e.g., FIG. 7), and a fourth optical addresser 404d configured to control a fourth beam 412d to address a fourth addressing region including the fourth ion chain 406d (e.g., FIG. 7). Each of the optical addressers 404a-404d are substantially similar to each other, so the second, third, and fourth optical addressers 404b-404d are only described in detail herein to the extent that they differ from the first optical addresser 404a. Like numbering will be used to discuss like parts of the optical addressers 404a-404d, with the letter “a” used to indicate components of the first optical addresser, the letter “b” used to indicate components of the second optical addresser, the letter “c” used to indicate components of the third optical addresser, and the letter “d” used to indicate components of the fourth optical addresser. It is noted that each of the optical addressers can be considered a configuration or arrangement that includes a plurality of optical components for addressing a respective ion as described in detail herein.

As shown in FIGS. 4 and 5, the optical addresser 404a emits a divergent beam 412a. In some aspects, the optical addresser 404a may include an optical fiber 408a configured to emit the divergent beam 412a. In some aspects, the optical addresser 404a may use free-space optics. A fiber collimator 416a is positioned downstream of the optical fiber 408a and is configured to collimate the beam 412a. The optical addresser 404a may include an acousto-optic deflector (AOD) 420a. In such aspects, the AOD 420a is configured to generate an angle range for the beam 412a based on a radiofrequency (RF) signal injected into a crystal of the AOD 420a. For example, the AOD 420a may deflect the collimated rays of the portion of the beam 412a entering the AOD 420a such that the rays of the beam 412a exiting the AOD 420a are deflected by a range of angles determined based on the RF signal injected into the crystal 420a of the AOD. In other aspects, the optical addresser 404a may include multiple AODs, two-dimensional AODs with crossed deflection axes, or other types of scanning devices.

A doublet of lenses 424a and an optional singlet lens 428a are configured to focus the beam 412a on a first image plane 432a. The optional singlet lens 428a may be a meniscus lens configured to introduce a field curvature to the beam 412a. In some aspects, the lens 428a may be configured to adjust the field curvature of the beam 412a such that a field curvature of the beam 412a is approximately equal to the Rayleigh range (“Z_{Rayleigh}”) of the beam 412a in the intermediate image plane 432a and is less than 0.01*Z_{Rayleigh} in the focal plane of the ion trap 270. In some aspects, the field curvature may be used to compensate for the effects of a microlens, as described in greater detail below.

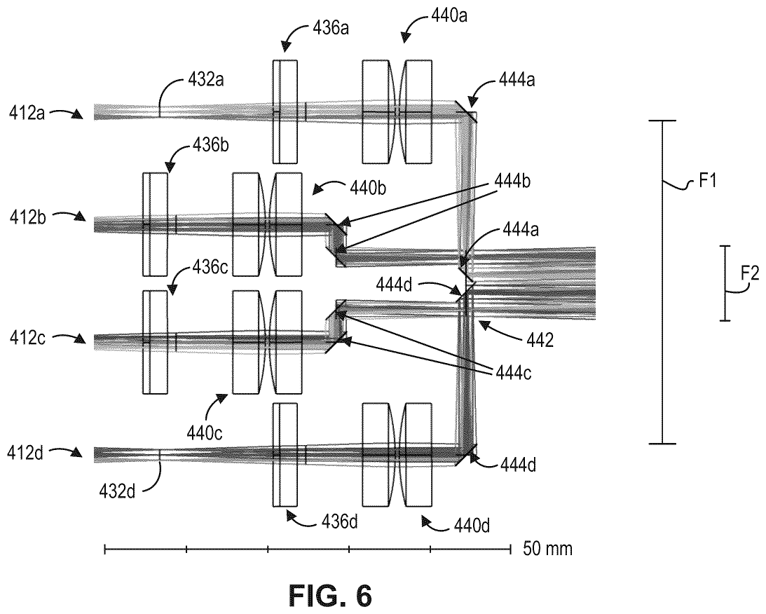

Referring now to FIGS. 4 and 6, a cylindrical lens 436a is configured to shape the beam 412a into an anamorphic beam. As shown in FIGS. 4 and 6, the cylindrical lens 436a is a single cylindrical lens (e.g., is not paired with a second cylindrical lens in a telescope configuration). For example, the cylindrical lens 436a may be configured to shape the beam 412a into an elliptical beam. In the illustrated embodiment, the anamorphic beam may have an aspect ratio of up to 1:20 (expressed as the ratio of focal spot size along the high numerical aperture (NA) axis relative to focal spot size the low NA axis). In such an aspect, this produces a 20 times smaller focal spot size along the high NA axis in a focal plane after a focusing lens. For example in some aspects, the aspect ratio of the anamorphic beam may be at least 1:2. For example in some aspects, the aspect ratio of the anamorphic beam may be at least 1:5. In another example, the aspect ratio may be between 1:2 to 1:10. In another example, the aspect ratio may be between 1:3 to 1:6. The cylindrical lens 436a is configured to shape the beam 412 such that the shaped beam has a high numerical aperture (NA) in an axis oriented along the axis of the ion chain. This configuration produces a narrow cross-section along the axis oriented along the axis of the ion chain, which reduces the likelihood of addressing ions adjacent to a target ion when addressing the target ion (i.e., optical crosstalk). The shaped beam has a lower NA in an axis oriented substantially transverse to the axis of the ion chain. This produces a wider cross-section in the axis oriented substantially transverse to the axis of the ion chain, which allows the shaped beam to clear the ion trap 270 close to a surface of the ion trap 270 and to clear a predetermined width of the ion trap 270, as required to target the desired ions in the ion trap 270. This wider cross-section also makes the beam 412a less susceptible to misalignment along the axis oriented substantially transverse to the axis of the ion chain. The width of the low NA portion of the shaped beam, however, should be narrow enough so that the shaped beam can pass through aperture(s) in the cryostat and/or trap housing(s) and/or travel past other components of the optical components of the QIP system 200 without being clipped.

As further shown, a doublet of lenses 440a is configured to collimate the beam 412a and focus the beam 412a on an intermediate image plane (not shown).

The beams 412a-412d then progress downstream to a combining region 442 or prism table that is configured to reduce a distance between the beams 412a-412d while maintaining spatial separation of the beams 412a-412d. For example, the combining region 442 may be configured to orient the beams 412a-412d so that the beams 412a-412d overlap in a same plane but are spatially separated. As illustrated in FIG. 6 in an example aspect, deflector pairs 444a-444d are aligned with the beams 412a-412d, respectively, and are configured to deflect the beams 412a-412d to reduce an overall spacing between the beams 412a-412d. As also shown in FIG. 6, each of the paired deflectors 444a-444d are oriented parallel to each other. In some aspects, the deflector pairs 444a-444d may be mirrors or prisms.

In the illustrated configuration, the combining region 442 is oriented at a relayed entrance of a pupil plane of each of microlens 472a-472d of the microlens array 468. As used herein, the phrase “pupil plane” refers to a plane in which divergent beams come together (e.g., converge). In such a configuration, the beams are collimated in the pupil plane, and all of the beams produced by a particular addresser (e.g., the addresser 404a, 404b, 404c, or 404d) overlap. This overlap allows for simultaneous compensation (e.g., for field-independent aberrations) and/or position adjustment of all of the beams produced by a particular addressor. These pupil planes for each of the addressers 404a-404d are relayed to the entrance of the pupil plane of the corresponding microlens or metalens sub-aperture. This allows the clean separation of the beams 412a-412d for each of the different addressing zones in the combining region 442 to translate to clean separation of the beam for the different addressing zones in the entrance pupil planes of the microlenses or metalens sub-apertures.

In other aspects, the combining region 442 may be oriented near an intermediate image plane. In other aspects, the combining region 442 may be oriented at a relayed image plane.

As is best shown in FIG. 6, the beams 412a-412d collectively have a fill factor F1 before entering the combining region 442 (e.g., before being deflected by the deflector pairs 444a-444d) and a second fill factor F2 after exiting the combining region 442 (e.g., after being deflected by the deflector pairs 444a-444d). As used herein, the phrase “fill factor” refers to a collective beam diameter of the beams 412a-412d formed by a particular addresser 404a-404d. The first fill factor F1 is lower than the second fill factor F2. In some aspects, the first fill factor F1 may be 5 times smaller than the second fill factor F2. In some aspects, the first fill factor F1 may be 4 times smaller than the second fill factor F2. This increase in fill factor in the combining region 442 is advantageous because such a configuration allows both bulky centimeter-scale optics and components to be used on a first (e.g., upstream) end of the multi-scale optical assembly and then taper the size of the assembly down to a very compact assembly with higher optical fill factor at a second (e.g., downstream) end of the optical assembly.

Moreover, according to an example aspect, an objective lens, shown as doublet 448, is positioned downstream of the combining region 442 and is configured to form a demagnifying relay with the lens doublet 440. The demagnifying relay formed by the doublets 448, 440 is configured to focus the beams 412a-412d on a second intermediate image plane 452.

A lens doublet 456 is configured to direct the beams 412a-412d through a window 460 in a cryostat housing such that the beams 412a-412d can interact with the ion chains confined by the ion trap 270.

Referring now to FIG. 7, an entrance of the pupil plane of the microlens array 464 is shown by the line 464. The microlens array 468 includes a plurality of microlenses 472. In the illustrated embodiment, the microlens array 468 includes four microlenses, microlenses 472a-472d. In the example embodiment, the microlenses 472a-472d have working distances of about 1.5 mm. In the example embodiment, a shape of the microlenses 472a-472d is low order aspheric. As used herein, the phrase “low order aspheric” refers to lens that is up to a 4^{th} order lens. A conical term may be added to the spherical surface of the microlenses 472a-472d to achieve a M² value of 1.05 or less across the FOVs for each of the microlenses 472a-472d. In aspects in which the microlenses 472a-472d have different working distances, higher order aspheric shapes of the microlenses 472a-472d may be required. Such higher order aspheric shapes may be defined with 4^{th} order or higher polynomials.

In other embodiments, the plurality of microlenses 472 may include more or fewer microlenses. The number of microlenses 472 corresponds to the number of addressing beams 412 and the number of ion chains 406. The microlens array 468 is positioned a distance d2 from the ion trap 270. In some aspects, the distance d2 is from about 2 mm to about 5 mm. In some aspects, the microlens array 468 is coupled to the ion trap 270. For example, some aspects, the microlens array 468 may be optically bonded to the ion trap 270. In another example, the microlens array 468 may be mounted to the ion trap 270 by a micro-mechanical assembly configured to adjust the microlens array 468 relative to the ion trap 270. In such aspects, coupling the microlens array 468 to the ion trap 270 may result in the microlens array 468 being tightly referenced to the ion chains 406a-406d. This can reduce sensitivity to drift, noise (e.g., due to vibrations, thermal contraction, air currents, and so forth), and so forth.

As shown in FIG. 7, each of the microlenses 472a-472d is aligned with one of the beams 412a-412d, respectively. Each of the microlenses 472a-472d is configured to focus the beams 412a-412d, respectively, onto the corresponding ion chains 406a-406d. The focused beams 412a-412d are illustrated schematically in FIG. 7 as three “collections” of rays, which indicates that a full addressing range (e.g., of angled rays) of the beams 412a-412d is focused on each of the respective ion chains 406a-406d. As shown in the illustrated embodiment, although the beams 412a-412d are very close together, the beams 412a-412d are sufficiently separated so that the beams 412a-412d do not address neighboring ion chains. In the illustrated embodiment, adjacent ion chains are a distance d1 apart. In some aspects, the distance d1 is 1 mm. In such aspects, a total addressing region is 4 mm wide. However, each of the individual optical addressers 404a-404d is configured to address a much smaller addressing region than the total addressing region. In the illustrated embodiment, the ion chains may be 189 μm long. In other aspects, the total region addressing region may be larger or smaller based on a number of individual addressing regions included in the total addressing region.

In the illustrated aspect, the microlenses 472a-472d are configured to produce beams having a beam waist of less than 1.5 μm along the axis of the trapped ion chains 406a-406d, a diameter of less than 30 μm along an orthogonal axis, and having a beam propagation ratio M² of less than 1.1. As used herein the orthogonal axis is orthogonal to both the axis of the trapped ion chains and the beam propagation direction.

For large addressing windows, such as the 4 mm addressing window of the present disclosure, it is advantageous to use a plurality of microlenses instead of one larger lens. For example, when addressing a 4 mm addressing region spaced 2 mm from an ion trap with a single beam, the angle of the beam is approximately 1 radian. Such an angle would require a very high NA. However, errors introduced by optics such as lenses typically increase with NA, reducing the accuracy of the addressing beam. In contrast, each of the microlenses 472a-472d is configured to address the first, second, third, or fourth addressing regions, respectively. In the illustrated aspect, each of the first, second, third, and fourth addressing regions is 200 μm. Since the first, second, third, and fourth addressing regions are each spaced 1 mm from each other, in this example, a total addressing region is 4 mm.

The multiple-zone Raman optical system 400 described herein facilitates producing QIP systems 200 that have more qubits per quantum chip. For example, the system 400 includes optical addressers 404a-404d that can be used to address different trapped ion chains 406a-406d of the ion trap 270. In some aspects, the system 400 can be controlled (e.g., by the general controller 205, the optical and trap controller 220, and so forth) to address the different ion chains 406a-406d simultaneously. Since the trapped ion chains 406a-406d may be entangled with each other via transport and swap operations and/or photonic interconnects, the system 400 can allow the multiple trapped ion chains to act like a network of ion chains 406a-406d.

In the examples described above, the trapped ion chains 406a-406d may be in close proximity to each other within the ion trap 270. In these examples, the optical addressers 404a-404d described herein are configured to reduce the likelihood of optical crosstalk between adjacent trapped ions within a single ion chain by having a beam waist of much less than the ion spacing. For example, in an ion chain with an ion spacing of 3 μm, the addressing beam may have a beam waist of less than 1.5 μm along the axis of the trapped ion chains, with a diameter of less than 30 μm along an orthogonal axis. In some aspects, the diameter may be less than 60 μm along an orthogonal axis. In some aspects, the addressing beam may have a beam waist of 1.5 μm along the axis of the trapped ion chains and 4.5 μm-12 μm along the orthogonal axis. Such configurations may produce beam diameters of 3 μm along the axis of the trapped ion chains and 9 μm-24 μm along the orthogonal axis. Further, the optical addressers 404a-404d described herein are configured to reduce the likelihood of optical crosstalk between adjacent trapped ion chains 406a-406d, the trapped ion chains 406a-406d may be separated by a distance large enough to mitigate the effects of spontaneous transmission. For example, the addressing beams produced by the system 400 have a beam waist of less than 1.5 μm, with a diameter of less than 30 μm. For example, in order to avoid optical crosstalk between adjacent trapped ion chains, for an ion chain of 64 ions and an ion spacing of 3 μm, a center-to-center spacing of adjacent trapped ion chains may be at least 1080 μm.

Although the system 400 is described as having four trapped ion chains 406a-406d and four optical addressers 404a-404d, in other aspects, the system 400 may include more or fewer trapped ion chains and optical addressers (i.e., the system 400 may be scaled up or down accordingly as long as there are at least two optical addressers). For example, variants of the system 400 can have as few as two trapped ion chains and two optical addressers. Variants of the system 400 can have as many as 64 trapped ion chains and 64 optical addressers.

In the configuration shown above, the system 400 may include conventional size lenses (e.g., not microlenses or metalenses) for the lenses 424a-424d, 428a-428d, 436a-436d, 440a-440d, 448a-448d, and 456a-456d. In other aspects, one or more of the lenses 424a-424d, 428a-428d, 436a-436d, 440a-440d, 448a-448d, and 456a-456d may be microlenses and/or metalenses. In other aspects, all of the lenses 424a-424d, 428a-428d, 436a-436d, 440a-440d, 448a-448d, and 456a-456d may be microlenses and/or metalenses.

Advantages of using microlenses and/or metalenses include the removal of large, bulky lenses, which can reduce the footprint of the system 400.

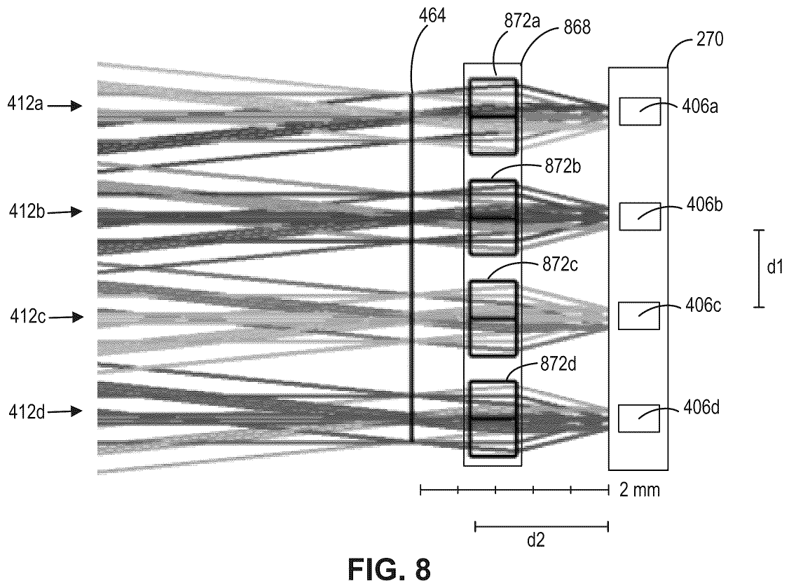

FIG. 8 illustrates a detail view of a portion of a variant of system 400 that includes a metalens 868 instead of a microlens array 468. Except the differences described below, the variant of the system 400 that includes the metalens 468 is the same as described above. In some aspects, the system 400 may include a metalenses 868 including a plurality of sub-lenses 872a-872d. The metalens 868 and sub-lenses 872a-872d are flat lenses. In some aspects, the metalens 868 may be configured as a continuous repeated pattern of sub-lenses 872a-872d in a single long lens. For example, the metalens 868 may form a periodic concentric pattern, with each pattern repeat forming a sub-lens 872a-872d concentrically centered around the center of one of the addressing zones of the ion trap 270. Therefore, configurations that include metalenses may not include the singlet lenses 428a-428d.

In some aspects, it may be advantageous to use metalenses 868 because metalenses have fewer optical aberrations and may eliminate the need for aspheric surface forms.

Further, although the beams 412a-412d are shown in substantially linear configurations in FIGS. 4-8, in some aspects, the system 400 may include mirrors and/or prisms configured to fold the beams 412a-412d. In some variants, at least a portion of the components upstream of the of the combining region 442 may be positioned on a module or card. In such aspects, the components for each of the beams 412a-412d may be on separate cards or modules. In the variants of the system 400 described herein, the system 400 is configured so that the combining region 442 is oriented such that the beams 412a-412d do not overlap downstream of the combining region 442.

The previous description of the disclosure is provided to enable a person skilled in the art to make or use the disclosure. Various modifications to the disclosure will be readily apparent to those skilled in the art, and the common principles defined herein may be applied to other variations without departing from the scope of the disclosure. Furthermore, although elements of the described aspects may be described or claimed in the singular, the plural is contemplated unless limitation to the singular is explicitly stated. Additionally, all or a portion of any aspect may be utilized with all or a portion of any other aspect, unless stated otherwise. Thus, the disclosure is not to be limited to the examples and designs described herein but is to be accorded the widest scope consistent with the principles and novel features disclosed herein.

What is claimed is:

1. A quantum information processing (QIP) system including:
an ion trap configured to confine at least a first trapped ion chain and a second trapped ion chain; and
a multiple-zone addressing system including:
a first optical addresser configured to control a first beam configured to address a first addressing zone including the first trapped ion chain;
a second optical addresser configured to control a second beam configured to address a second addressing zone including the second trapped ion chain; and
a combining region configured to reduce a fill factor of the first beam and the second beam while maintaining spatial separation of the first beam and the second beam.

2. The QIP system of claim 1, further comprising:
a microlens array comprising a first microlens configured to focus the first beam on the first trapped ion chain and a second microlens configured to focus the second beam on the second trapped ion chain.

3. The QIP system of claim 2, wherein the first and second microlenses are low order aspheric lenses.

4. The QIP system of claim 2, wherein the combining region is oriented at a relayed entrance of a pupil plane of each of the first and second microlenses.

5. The QIP system of claim 2, wherein the first beam and the second beam focused on the first and second ion chains, respectively, each have a beam waist of less than 1.5 μm along an axis of the ion chain and a diameter of less than 30 μm along an orthogonal axis.

6. The QIP system of claim 2, further comprising a meniscus lens configured to introduce a field curvature to the first beam and the second beam.

7. The QIP system of claim 1, further comprising:
a metalens array comprising a first metalens configured to focus the first beam on the first trapped ion chain and a second metalens configured to focus the second beam on the second trapped ion chain.

8. The QIP system of claim 1, wherein a center-to-center distance between the first trapped ion chain and the second trapped ion chain is approximately 1 mm.

9. The QIP system of claim 1, wherein the combining region includes at least a first deflector pair configured to fold the first beam and a second deflector pair configured to fold the second beam.

10. The QIP system of claim 9, wherein the first deflector pair and the second deflector pair are configured to reduce a spacing between the first beam and the second beam.

11. The QIP system of claim 1, wherein the combining region is configured to reduce a fill factor of the first beam and the second beam such that the fill factor of the first beam and the second beam upstream of the combining region is at least fourfold larger than the fill factor of the first beam and the second beam downstream of the combining region.

12. The QIP system of claim 1, wherein the multiple-zone addressing system comprises an objective lens that is positioned downstream of the combining region.

13. The QIP system of claim 1, wherein the multiple-zone addressing system includes a cylindrical lens positioned upstream of the combining region and configured to shape the first and second beams into anamorphic beams having an aspect ratio of up to 1:20.

14. The QIP system of claim 1, wherein the combining region is configured to orient the first beam and the second beam so that the first beam and the second beam overlap in a plane but are spatially separated.

15. A quantum information processing (QIP) system including:
an ion trap including at least one addressing zone including a trapped ion chain; and
an addressing system configured to address the at least one addressing zone of the ion trap, the addressing system including:
an optical addresser configured to control a beam configured to address the at least one addressing zone including the trapped ion chain; and
a microlens array including a microlens configured to focus the beam on the trapped ion chain or a metalens array including a metalens configured to focus the beam on the trapped ion chain.

16. The QIP system of claim 15, wherein the microlens array is coupled to the ion trap.

17. The QIP system of claim 15, wherein the microlens is a low order aspheric lens.

18. The QIP system of claim 15, wherein the beam focused on the trapped ion chain has a beam waist of less than 1.5 μm along an axis of the ion chain and a diameter of less than 30 μm along an orthogonal axis.
